(19) United States
(12) Patent Application Publication
(10) Pub. No.: US 2015/0248644 A1
(43) Pub. Date: Sep. 3, 2015

(54) Unified Business Intelligence Application

(71) Applicant: Visier Solutions, Inc., Vancouver (CA)

(72) Inventors: Geoffrey Benjamin Zenger, New Westminster (CA); Maxim Bitel, North Vancouver (CA)

(73) Assignee: Visier Solutions, Inc., Vancouver (CA)

(21) Appl. No.: 14/193,203

(22) Filed: Feb. 28, 2014

(51) Int. Cl. G06Q 10/10

(52) U.S. Cl. CPC G06Q 10/105

(57) ABSTRACT

An analytics platform provides a unified business intelligence application that includes querying, analysis, reporting, and prediction (QARP). The analytics platform includes an analytics engine that stores data identifying a plurality of dimensions associated with a population. The population includes multiple population members and each dimension is associated with multiple dimension members. The data includes likelihood scores for at least a subset of the plurality of dimension members, where the likelihood scores are associated with satisfaction of a criterion. The analytics engine is configured to determine a predicted likelihood of a particular population member satisfying the analysis criterion based on the likelihood scores of the dimension members associated with the population member. The analytics engine may store the predicted likelihood as a calculated value that can be counted, summed, etc. during operation.

### BACKGROUND

Business enterprises often use computer systems to store and analyze large amounts of data. For example, an enterprise may maintain large databases to store data related to sales, inventory, accounting, human resources, etc. To analyze such large amounts of data, an information technology (IT) department at the enterprise may hire business integrators and consultants to generate enterprise-specific business reports (such as by developing custom reporting software applications). Each of the software applications may be configured to provide different business intelligence functionality. Having multiple software applications may increase training and operating costs and may reduce the usefulness or timeliness of the applications due to the complexity of integrating and cleansing data from multiple sources. This may diminish the overall usefulness of such applications in the enterprise.

### SUMMARY

A unified business intelligence application presents interactive interfaces to a client (e.g., a client device and/or client application) and may be a one-stop business tool that addresses all four business intelligence functionalities: querying, reporting, analysis, and prediction. When the application is executed, interactive GUIs may be generated to receive queries and to display reports including fact data (e.g., from one or more databases), analysis results generated based on the fact data, and/or prediction results generated based on the analysis results.

For example, in the context of a workforce analytics application, an interactive GUI may display fact data related to employees that satisfy a particular analysis criterion (e.g., resigned within a particular date range). The analysis results may identify an amount of influence (e.g., 15%) of each employee characteristic (e.g., a particular work location, a particular number of training hours, a particular provenance, etc.) on satisfying the particular analysis criterion. To illustrate, if a large percentage of employees that resigned in the past 12 months were located in a New York office of a company, then “Location: New York” is determined to have a large amount of influence. The analysis results may be used to generate prediction results indicating which of the remaining employees are most likely to satisfy the analysis criterion (i.e., resign in the near future). To illustrate, if “Location: New York” is determined to have a large amount of influence on employee resignation/retention, then employees in the New York office may be predicted to have a higher risk of resigning than employees in other offices.

### BRIEF DESCRIPTION OF THE DRAWINGS

FIG. 1 is a diagram that illustrates a particular embodiment of a system that includes a unified business intelligence application;

FIG. 2 is a diagram that illustrates a particular embodiment of an analytics engine of the system of FIG. 1;

FIG. 3 illustrates a first particular embodiment of a graphical user interface (GUI) that is generated by the system of FIG. 1;

FIG. 4 illustrates a second particular embodiment of a GUI that is generated by the system of FIG. 1;

FIG. 5 illustrates a third particular embodiment of a GUI that is generated by the system of FIG. 1;

FIG. 6 illustrates a fourth particular embodiment of a GUI that is generated by the system of FIG. 1;

FIG. 7 illustrates a fifth particular embodiment of a GUI that is generated by the system of FIG. 1;

FIG. 8 illustrates a sixth particular embodiment of a GUI that is generated by the system of FIG. 1;

FIG. 9 is a flowchart of a first particular embodiment of a method of operation at an analytics engine; and

FIG. 10 is a flowchart of a second particular embodiment of a method of operation at an analytics engine.

### DETAILED DESCRIPTION

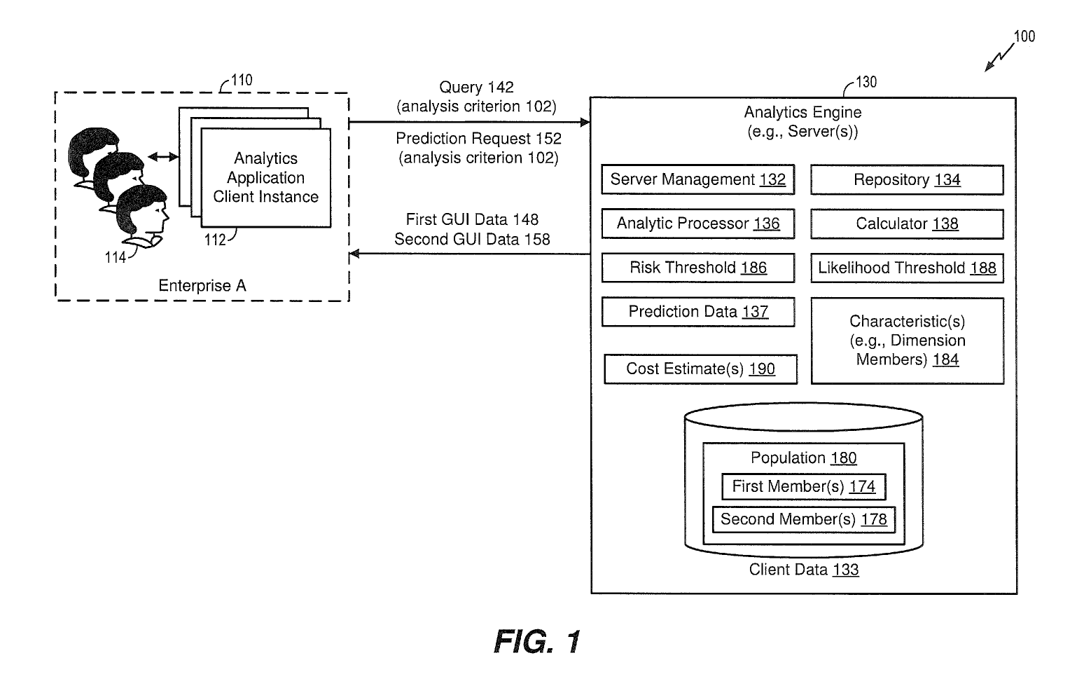

Referring to FIG. 1, a particular embodiment of a system 100 that includes a unified business intelligence application is shown. The system 100 includes a client-server analytics platform corresponding to a unified business intelligence application. The client portion of the platform is illustrated in FIG. 1 by client instances 112. The server portion of the platform is illustrated in FIG. 1 by an analytics engine 130.

In a particular embodiment, each of the client instances 112 may be a “thin” client application, such as an Internet-accessible web application, that presents graphical user interfaces (GUIs) based on communication with the analytics engine 130. In FIG. 1, the analytics platform is available to an enterprise 110 (e.g., a company, a corporation, a government department, an education institution, or other entity). The enterprise 110 is associated with one or more users 114 (e.g., employees) that have the ability to execute the one or more client instances 112. Each of the users 114 may log in to a website or web application corresponding to a client instance 112 using a browser of a computing device, such as a desktop computer, a laptop computer, a mobile phone, a tablet computer, etc. The process of logging in identifies the user and the rights he/she may have with respect to the data that is being accessed.

It should be noted that although a single enterprise 110 is shown in FIG. 1, in alternate embodiments, any number of enterprises and client instances may be present in the system 100. Each enterprise 110 may provide the analytics platform (e.g., the client instances 112 and/or the analytics engine 130) access to their respective client data 133. For example, the enterprise 110 may upload the client data 133 to the analytics engine 130. The uploaded data may be “cleaned” (e.g., via data integrity checks and error-correction operations), transformed, and loaded into an in-memory database at the analytics engine 130. The client data 133 may represent internal enterprise data that is analyzed by the analytics platform. For example, when the analytics platform is a workforce analytics platform, the client data 133 may represent internal databases that store data regarding employee compensation, diversity, organizational structure, employee performance, recruiting, employee retention, retirement date, etc.

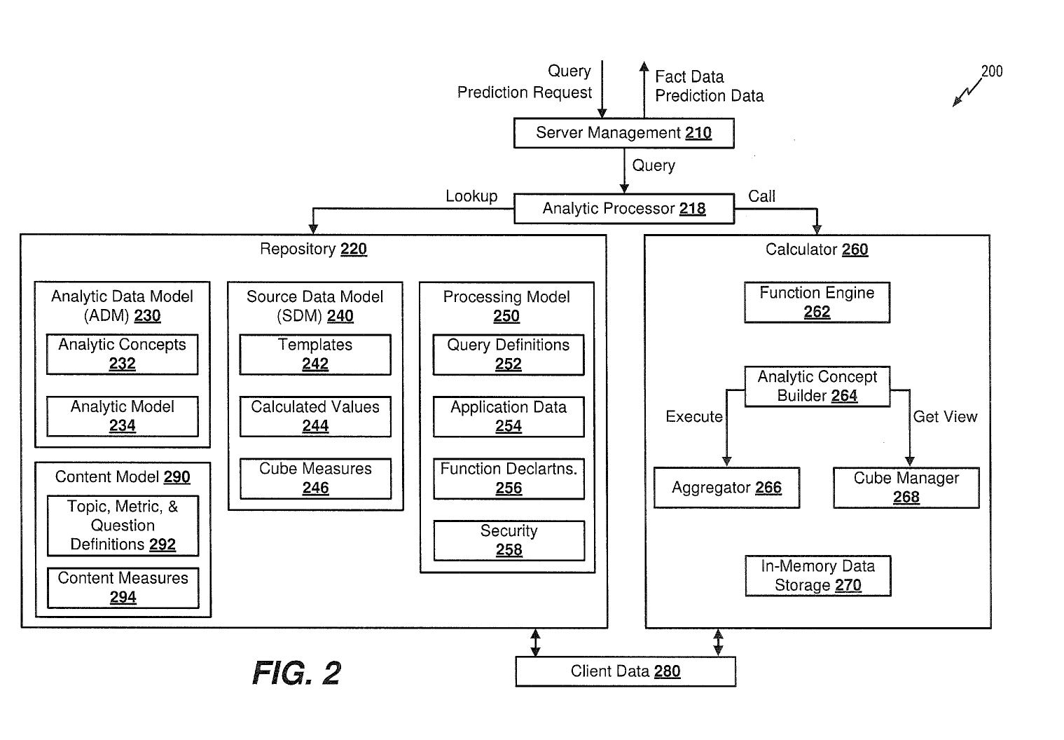

The analytics engine 130 may be configured to receive queries from the client instances 112, execute the queries, and provide results of executing the queries to the client instances 112. In a particular embodiment, the analytics engine 130 includes a server management module 132 that is configured to manage a server environment and provide interfaces to handle requests. For example, the server management module 132 may communicate with the client instances 112. In a particular embodiment, the communication is performed via scripts, servlets, application programming interfaces (APIs) (e.g., a representational state transfer (REST) API), etc. The server management module 132 may also expose services and/or data to the client instances 112. For example, exposed services and data may include query output, session and user account management services, server administration services, etc. The server management module 132 is further described with reference to FIG. 2.

The analytics engine 130 may also include a repository 134. In a particular embodiment, the repository 134 stores models, such as data models and processing models. The models may include query declarations and metric definitions, as further described with reference to FIG. 2. The models may also include analysis and prediction models, as further described herein. The analytics engine 130 may further include an analytics processor 136 and a calculator 138. The analytics processor 136 may be configured to coordinate lookup and function call operations during query execution, as further described with reference to FIG. 2. The calculator 138 is configured to access data (e.g., in-memory data cubes) to calculate the value of functions and metrics, as further described with reference to FIG. 2.

During operation, the analytics engine 130, as described herein, may send data to the client instances 112 that is used to generate GUIs related to the four “core” business intelligence functionalities: querying, analyzing, reporting, and prediction (QARP).

The enterprise 110 may acquire access to the analytics platform (e.g., via a purchase, a license, a subscription, or by another method). One of the users 114 may log in to one of the client instances 112. The analytics platform may support analysis regarding a set of semantic items. A “semantic item” may be a high-level concept that is associated with one or more terms (or lingo), questions, models, and/or metrics. For example, in the context of workforce analytics, semantic items may be associated with terms such as “employee,” “organization,” “turnover,” etc. The semantic items may also be associated with business questions such as “What is the ‘Cost’ of ‘Employee’ in the ‘Sales’ organization in ‘North America’ in ‘First Quarter, 2012’?”, “How is my ‘Cost’ ‘now’ compared to ‘the same period last year’?”, etc. The semantic items may further be associated with business models, such as models for cost of turnover, indirect sales channel revenue, etc. Semantic items may include metrics or key performance indicators (KPIs), such as revenue per employee, cost per employee, etc.

When the user 114 logs in to a particular client instance 112, the client instance 112 may display a graphical user interface (GUI) that is operable to generate various data analysis queries to be executed by the analytics engine 130. For example, the particular client instance 112 may send (e.g., via a network, such as a local area network (LAN), a wide area network (WAN), the Internet, etc.) a query 142 to the analytics engine 130. The query 142 may identify an analysis criterion 102.

The analytics engine 130 may determine that one or more first members 174 of a data set corresponding to a population 180 may satisfy the analysis criterion 102. As used herein, a “population” may refer to a set of items or objects for which data is collected and maintained. In the context of a workforce analytics application, the population 180 may correspond to all employees of the enterprise 110. Each employee may be referred to as a “population member.” Each population member may be associated with a “dimension member” of multiple “dimensions” for which the analytics engine 130 has available data. As used herein, a “dimension” may have one or more possible values, referred to as “dimension members.” For example, each employee of the enterprise 110 may be associated with a particular dimension member of a “Location” dimension. Employees in the United States may be associated with a “US” dimension member of the “Location” dimension; employees in Canada may be associated with a “Canada” dimension member of the “Location” dimension, etc. Thus, in relational database terms, a “population” may be analogous to a set of rows of a table. For example, a table may include a set of rows corresponding to American employees and a set of rows corresponding to Canadian employees. Each set of rows may be considered a separate population and the sets of rows may collectively be considered a single population. “Population members” may be analogous to individual rows of the table, a “dimension” may be analogous to a column of the table, and “dimension members” may be analogous to values stored in the column. It should be noted that dimensions may be hierarchical. For example, “US,” “Colorado,” and “Denver” may be dimension members in three hierarchy levels of a “Location” dimension.

To illustrate, the analysis criterion 102 may be associated with employee retention/resignation. For example, the analysis criterion 102 may correspond to “Employees who resigned between Apr. 1, 2012 and Mar. 31, 2013,” “Resignation rate for Apr. 1, 2012 to Mar. 31, 2013,” etc. The enterprise 110 may include employees in various countries, including the United States (US), Canada, and the United Kingdom (UK). The user 114 may request to view a visual comparison of the resignation rate in each of the aforementioned countries. Thus, in this example, a subset of the employees of the enterprise 110 who resigned between Apr. 1, 2012 and Mar. 31, 2013 satisfies the analysis criterion 102.

It should be noted that although various embodiments are described herein with reference to employee resignation and a workforce analytics application, this is for example only and not to be considered limiting. For example, the described techniques may be used to predict a likelihood of filling an open requisition position in a certain amount of time based on analysis of historical data indicating time taken to fill previous requisition positions. As another example, the described techniques may be used to predict an amount of money to be paid out to an employee due to unused vacation days (also referred to as “leave liability”). Further, the described techniques may be used to predict a cost of replacing an employee that has resigned (e.g., according to a particular model), as further described herein. In alternate embodiments, the described techniques may be used to query, analyze, report, and/or predict other types of data in other types of applications (e.g., sales, finance, inventory, cash, sensor input, etc.).

In response to receiving the query 142, the analytics engine 130 may determine population members that satisfy the analysis criterion 102. For example, the analytics engine 130 may execute the query 142 to generate and populate a multidimensional cube with client data 133 corresponding to employees (e.g., the population 180). The multidimensional cube may be stored in the analytics engine 130, as further described with reference to FIG. 2. In a particular embodiment, a dimension of the multidimensional cube may correspond to “Exit date,” a second dimension may correspond to “Resigned”, and a third dimension may correspond to “Location.” The analytics engine 130 may determine the resignation rate for each location (e.g., US, Canada, and UK) based on the cube. For example, the analytics engine 130 may determine that the first members 174 of the data set corresponding to the population 180 satisfy the analysis criterion 102 (i.e., resigned between Apr. 1, 2012 and Mar. 31, 2013). The analytics engine 130 may apply a “Location” filter to the first members 174 and determine a corresponding resignation rate. Populating multidimensional cubes and using such cubes to evaluate measures is further described with reference to FIG. 2.

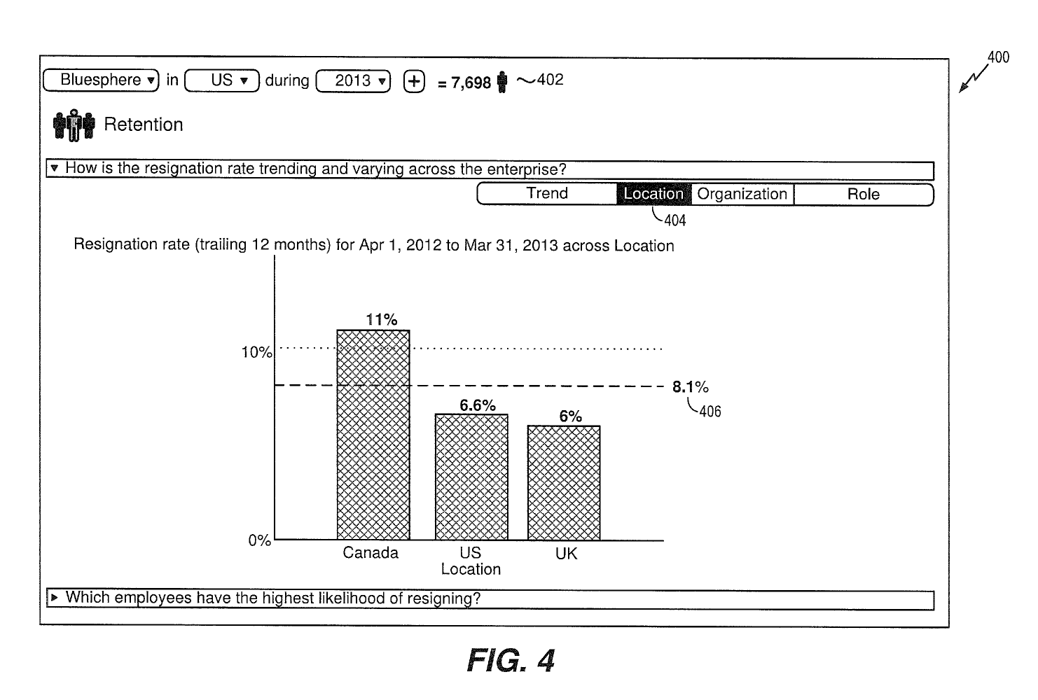

The analytics engine 130 may generate first GUI data 148 based on the computed client result values. For example, the analytics engine 130 may generate the first GUI data 148 indicating the resignation rate for each of the aforementioned locations between Apr. 1, 2012 and Mar. 31, 2013. The analytics engine 130 may send the first GUI data 148 to the client instance 112. The client instance 112 may use the first GUI data 148 to generate a GUI that illustrates the resignation rate on a country-by country basis. An example of such a GUI is described with reference to FIG. 4. In alternate embodiments, the first GUI data 148 may also include a list of resigned employees, characteristics associated with the resigned employees, etc.

In a particular embodiment, the user 114 may request to view a visual representation of employee characteristics that have a high correlation with employee resignations. In this embodiment, the analytics engine 130 may identify certain characteristics 184 in response to the query 142. Each of the characteristics 184 may be associated with at least one of the first members 174. In an illustrative embodiment, a regression model may be used to identify the characteristics 184. In alternate embodiments, a different analytical model may be used.

In a particular embodiment, analysis and prediction models may be determined and stored for various concepts and metrics based on historical data. For example, for employee resignation, a likelihood of leaving may be computed for a dimension member using Equation 1:

L=GC/GP, Equation 1

where L is the likelihood of leaving, GC is a Group Criterion value (e.g., a value of the analysis criterion 102, such as resignation rate, over the dimension member), and GP is a distinct Group Population count. To illustrate, for a member “Colorado” of a dimension “Location” and for a particular historical time period (e.g., the previous 18 months), a value of L=10/200=5% may be computed if 10 employees located in Colorado resigned for at least some part of the previous 18 months out of 200 total employees in an analysis population. To illustrate, the analysis population may correspond to all employees or employees that share a particular characteristics (e.g., employees that have a performance level of “2”). Given a total set of dimension members, the dimension members associated with each employee may be identified and sorted based on their corresponding likelihoods of resigning (e.g., values of L). In this example, the characteristics 184 may correspond to one or more dimension members that have a value of L that is greater than a likelihood threshold 188.

Thus, the model (e.g., the employee resignation model) may be computed from all members of the overall population 180 not just an analysis population that the user 114 is interested in. Although predictions may only be made for the analysis population, as further described herein, the analytics engine 130 may perforin model computation globally, so that the same model can be applied when comparing different analysis populations (e.g., resignation rates for Managers vs. Technicians) to provide a more meaningful “apples-to-apples” comparison for historical and predicted values. Further, because the model is globally computed, the predicted value for a particular employee does not change when the analysis population (e.g., application context) specified by the user 114 changes.

In a particular embodiment, the model may be based on scores for fewer than all available dimensions/dimension members. For example, a dimension member may be excluded during analysis and prediction if the dimension member is associated with less than a threshold amount (e.g., 1%) of the total population 180. Alternately, or in addition, the model may be built based on a set of dimensions that have previously been determined to correlate to the analysis criterion 102 (e.g., employee resignation) based on research and/or empirical study. The analytics engine 130 may generate/update models periodically (e.g., monthly), in response to user input, in response to particular events, or any combination thereof.

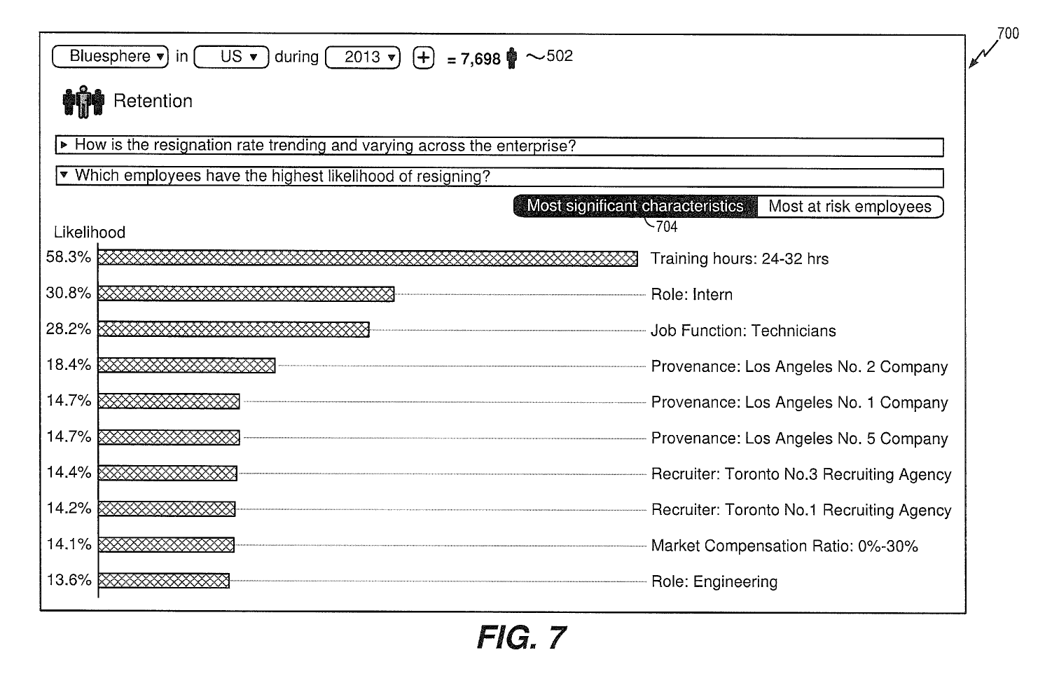

The analytics engine 130 may generate the first GUI data 148 indicating the characteristics 184 and corresponding likelihood scores. The client instance 112 may use the first GUI data 148 to generate a GUI that illustrates the likelihood scores corresponding to one or more of the characteristics 184 (e.g., dimension members having a high value of L). An example of such a GUI is described with reference to FIG. 7 which illustrates resignation likelihoods for a set of exemplary dimension members. In a particular embodiment, the GUI may include the one or more of the characteristics 184 in order of rank (e.g., ascending or descending order of rank).

The operations described with reference to the query 142, the analysis criterion 102, and the first GUI data 148 may thus correspond to querying, analyzing, and reporting (QAR) regarding various measures/metrics, including but not limited to employee resignation rate, filling open requisition positions, leave liability, cost of replacement, etc. The system 100 may also provide prediction results, thereby providing a unified querying, analyzing, reporting, and prediction (QARP) system. To illustrate, the user 114 may request to view a visual representation of prediction results associated with an analysis criterion (e.g., the analysis criterion 102). For example, after seeing which characteristics are the largest contributors to employee resignation, the user 114 may request to see which employees have a high predicted likelihood of resigning (e.g., a “risk of leaving” score that is higher than a threshold 186). The client instance 112 may send (e.g., via a network, such as a local area network (LAN), a wide area network (WAN), the Internet, etc.) a prediction request 152 to the analytics engine 130. The prediction request 152 may identify the analysis criterion 102.

The analytics engine 130 may execute one or more query requests in response to receiving the prediction request 152. The analytics engine 130 may identify the characteristics 184, as described above, in response to the prediction request 152. In a particular embodiment, the analytics engine 130 may use previously identified characteristics 184 (e.g., identified in response to the query 142), which may have been stored in the client data 133.

The analytics engine 130 may generate prediction data 137 indicating one or more second members 178 of the data set corresponding to the population 180 and a likelihood associated with each of the second members 178. To illustrate, in FIG. 1, the population 180 may correspond to data for all employees of an enterprise, the first members 174 may correspond to data for a first subset of employees that have previously resigned, and the second members 178 may correspond to data for a second (mutually-exclusive) subset of employees that have not yet resigned and that are predicted as having higher than a threshold likelihood of resigning. In a particular embodiment, the second members 178 may be part of an analysis population identified by the user 114 using a context filter, as further described herein.

For example, in response to the prediction request 152, the analytics engine 130 may identify dimension members associated with the employees in the analysis population. The analytics engine 130 may use an employee resignation model to determine the likelihood scores (L) for each dimension member, and may compute a “risk of leaving” score for each of the employees in the analysis population based on the likelihood scores (L). For example, because a current employee “Benita Atkinson” is an Intern Technician, if the dimension members Intern and Technician have large likelihood scores, Benita Atkinson may be predicted as having a high “risk of leaving” score, and therefore a high likelihood of resigning.

In a particular embodiment, a top N (e.g., 5) likelihood scores (e.g., values of L) associated with an employee may be averaged to compute the “risk of leaving” score for that employee. To illustrate, if a particular employee “Joe Smith” has top 5 L values of 5% for a “Tenure” dimension, 10% for a “Performance Level” dimension, 8% for a “Time Since Last Promotion” dimension, 3% for a “Salary Change” dimension, and 12% for a “Training Dollars” dimension, then Joe Smith's “risk of leaving” score may be computed as (5+10+8+3+12)/5=7.6%. In a particular embodiment, the “risk of leaving” score may be stored at the analytics engine 130 as a ratio of integers to simplify computation and storage (e.g., 7.6% may be approximated as the ratio 1:13). In alternate embodiments, a different method of computing prediction results may be used.

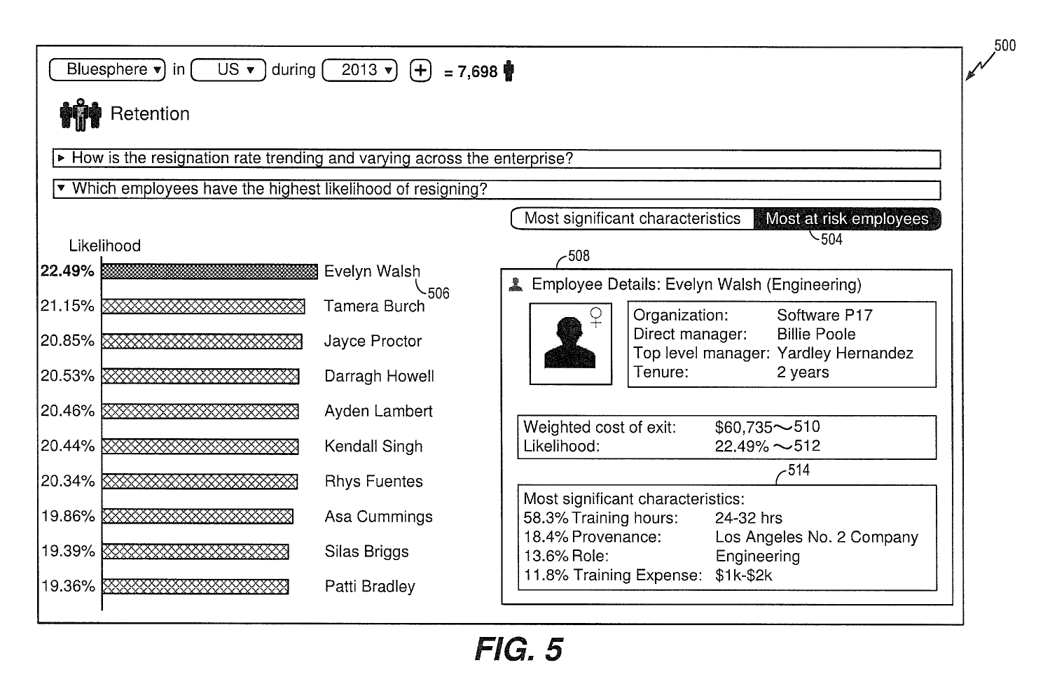

In a particular embodiment, the prediction data 137 may include a cost estimate 190 of satisfying the analysis criterion 102 associated with each of the second members 178. For example, a cost estimate 190 of each employee resigning may be determined by weighting the “risk of leaving” scores based on a salary midpoint of the employee. To illustrate, the analytics engine 130 may compute a cost estimate of a particular employee resigning (e.g., a weighted cost of exit of $60,735) by multiplying a salary midpoint (e.g., $270,053) of the employee by the “risk of resigning” score of the employee (e.g., 22.49%). Examples of the cost estimate(s) 190 are further described with reference to FIGS. 5, 6, and 8. In a particular embodiment, the prediction data 137 may also include an expected cost of replacement (e.g., determined as 1.5 times the employee's salary).

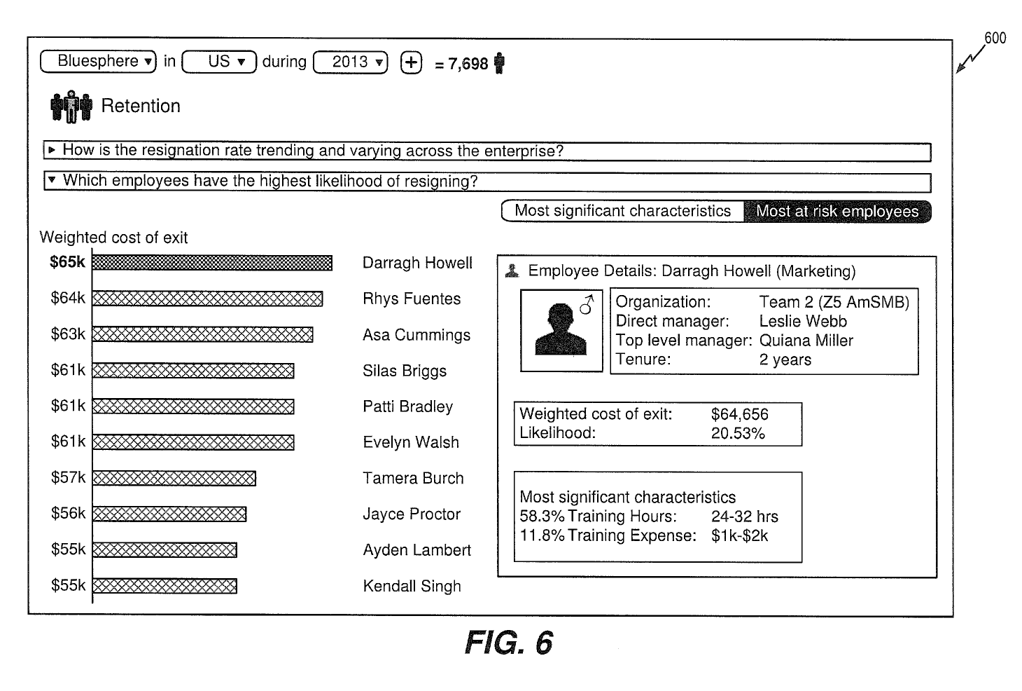

The prediction data 137 may be ranked based on the “risk of resigning” scores or based on the cost estimates. The analytics engine 130 may generate second GUI data 158 that identifies the top N (e.g., N=20) employees (e.g., in descending order of score, cost of resignation, or cost of replacement). The analytics engine 130 may send the second GUI data 158 to the client instance 112. The client instance 112 may use the second GUI data 158 to generate a GUI that identifies one or more of the second members 178 and their associated likelihoods of resigning, cost of resignation, and/or cost of replacement. Examples of such GUIs are described with reference to FIGS. 5 and 6.

In a particular embodiment, the second GUI data 158 may include additional information associated with specific population members. For example, in response to the user 114 selecting a particular employee that is predicted to have a high likelihood of resigning, the analytics engine 130 may provide the employee's name, department, role, job function, organization, manager, tenure, gender, photograph, etc. The second GUI data 158 may also include information indicating why a particular population member is predicted to have a high likelihood of satisfying the analysis criterion 102. For example, the second GUI data 158 may include, for a particular employee, a list of associated dimension members that have high L scores.

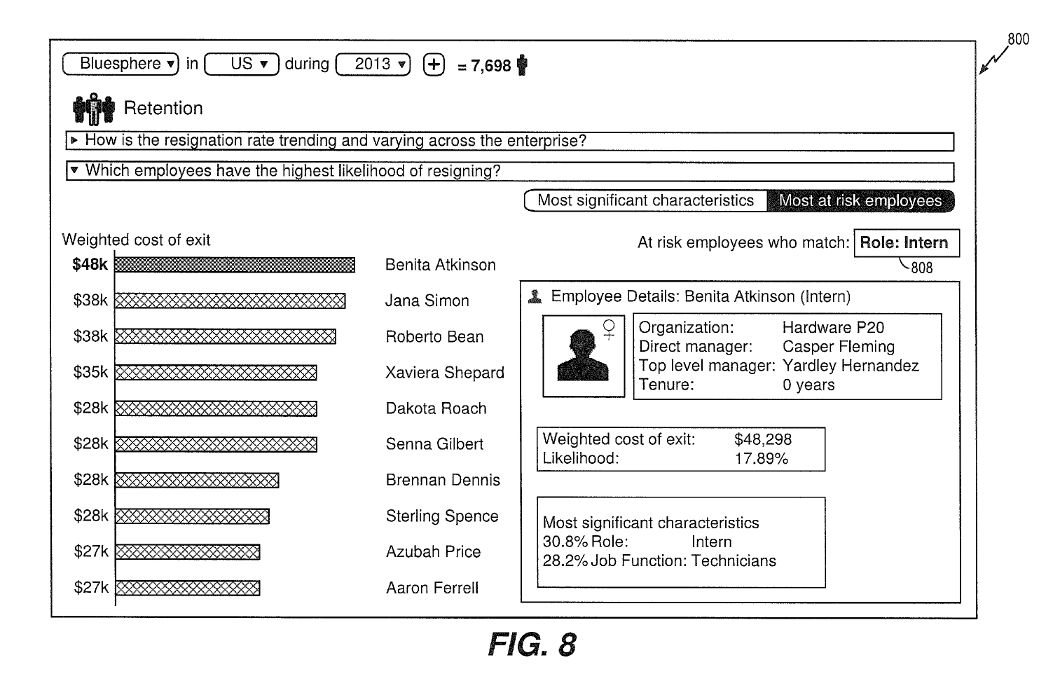

In a particular embodiment, the analytics engine 130 may perform analysis and prediction with respect to specific dimension members that define an analysis population. For example, the user 114 may request to view a list of technicians that have a relatively high likelihood of resigning. In this embodiment, “Job Function: Technicians” is used as a filter to define the analysis population and each of the second members 178 is a technician. An example of such a GUI is described with reference to FIG. 8.

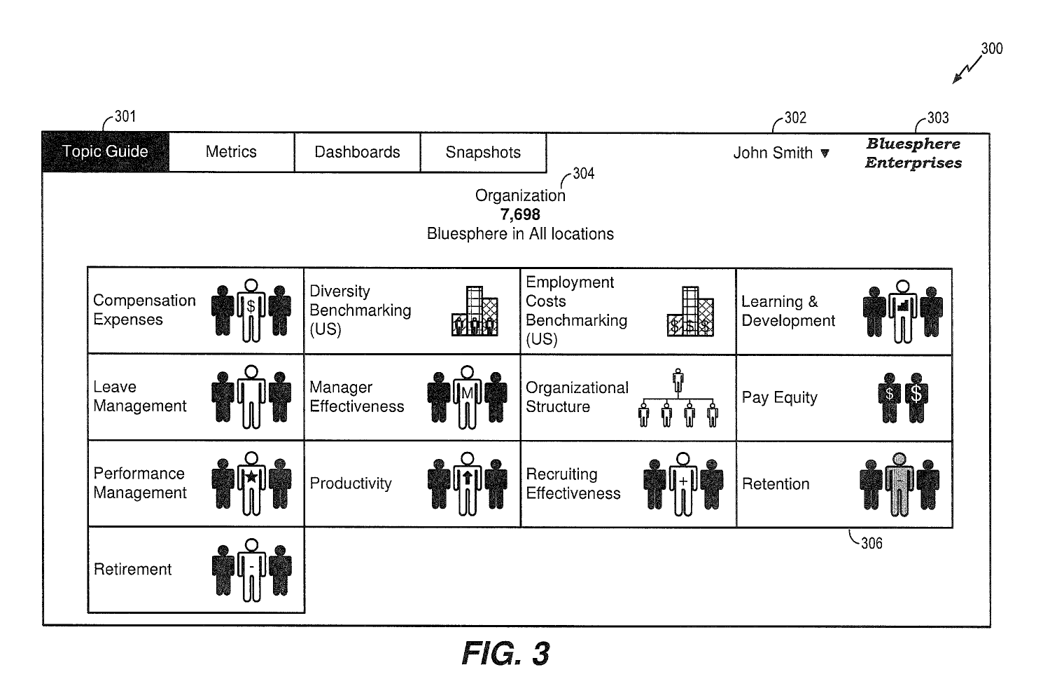

In a particular embodiment, the prediction request 152 may indicate a particular geographic location, a particular organization in the enterprise 110, or a combination thereof, to define the analysis population. To illustrate, the prediction request 152 may correspond to a request to view employees in a Los Angeles office that have a high likelihood of resigning, employees in a Sales department that have a high likelihood of resigning, etc. The analytics engine 130 may identify the second members 178 that are associated with the particular geographic location, the particular organization, or a combination thereof, as further described with reference to FIGS. 2-3 regarding “application context.”

The system 100 of FIG. 1 thus illustrates a unified business intelligence application that is configured to act as a one-stop business tool and provide all four “core” business intelligence functionalities: querying, analyzing, reporting, and prediction (QARP). When the unified business intelligence application is executed, interactive GUIs may be generated to display reports including fact data (e.g., from one or more databases), analysis results generated based on the fact data, and/or prediction results generated based on the analysis results.

FIG. 2 is a diagram to illustrate a particular embodiment of an analytics engine 200. In an illustrative embodiment, the analytics engine 200 corresponds to the analytics engine 130 of FIG. 1. The analytics engine 200 may include a server management module 210 (e.g., corresponding to the server management module 132 of FIG. 1), an analytic processor (e.g., corresponding to the analytic processor 136 of FIG. 1), a repository 220 (e.g., corresponding to the repository 134 of FIG. 1), and a calculator 260 (e.g., corresponding to the calculator 138 of FIG. 1). In a particular embodiment, each component of the analytics engine 200 corresponds to hardware and/or software (e.g., processor executable instructions) configured to perform particular functions described herein. In one example, the analytics engine 200 corresponds to a server-side architecture of an analytics platform and is implemented by one or more servers, such as web servers and/or data servers.

The server management module 210 may be configured to manage a server environment and entry points that are exposed to clients, such as the client instances 112 of FIG. 1. For example, client requests may be in the form of queries (e.g., requests to execute specific queries on client data 280) or prediction requests (e.g., requests to predict likelihoods of population members satisfying a particular analysis criterion based on analysis of the client data 280). The results of executing a specified query, responding to prediction requests, or both, may be used by the client instances 112 to generate particular business analysis interfaces, reports, etc.

The analytic processor 218 may be configured to manage various operations involved in query execution. For example, the analytic processor 218 may perform lookup operations with respect to the repository 220 and call (e.g., a function call) operations with respect to the calculator 260. The repository 220 may store various data models and data definitions that are referenced during query execution. For example, the repository 220 may store an analytic data model (ADM) 230, a source data model (SDM) 240, a processing model 250, and a content model 290.

The SDM 240 may define a maximal set of dimensions and fact tables that can be constructed from a particular client data set (e.g., the client data 280). A dimension may be a field that can be placed on an axis of a multidimensional data cube that is used to execute a query, as further described herein. For example, “Location” may be a dimension, and members of the “Location” dimension may include “US,” “UK,” and “Canada.” It should be noted that there may be multiple levels of a dimension. For example, the “US” dimension may include a second level that includes the members “Texas,” “New York,” and “California.” A fact table may be a collection of facts, where facts correspond to data points (e.g., database entries) and occupy the cells of a multidimensional data cube.

In addition to dimensions and fact tables, the SDM 240 may include fact table templates 242, calculated values 244, and cube measures 246 (alternately referred to as “fact table measures”). The fact table templates 242 may define a maximal set of dimensions, measures, and calculated values that can be used to construct a particular multidimensional data cube. The calculated values 244 may be represented by functions that accept a fact as input and output a calculated value to be appended to that fact. For example, given the value “Salary” in a fact table, a “Ten times Salary” calculated value may append a value to each fact equal to ten times the value of the “Salary” of that fact. As another example, “Tenure” may be a calculated value that does not exist in the client data 280 as a static value. Instead, a “Tenure” calculated value may accept an employee hire date and a specified date as input and may return a value representing the employee's tenure on the specified date. The cube measures 246 may be functions that accept a set of facts as input and output a value. For example, given all employees in Canada as input, a “Sum of Salary” measure may output the sum of salaries of all Canadian employees. As another example, a “Count” measure may count all of the facts in a set of cells and return the count. Measures that represent a performance assessment (e.g., key performance indicators (KPIs)) are also referred to herein as metrics.

The ADM 230 may include analytic concepts 232 and an analytic model 234. The analytic concepts 232 may be functions that accept an application context as input and output a set of dimension members. In a particular embodiment, application context may be dynamically adjusted by a user, as further described with reference to FIG. 3. The analytic model 234 may represent a set of mathematical formulae that can be used during query execution, as further described herein.

The processing model 250 may include query definitions 252, application data 254, function declarations 256, and security modules 258. Each query (or prediction request) may be associated with a query definition 252 that includes a set of function calls, measures, and parameter values. The query definition 252 may thus define an execution path to be used by the analytic processor 218 to generate the result of the query (or prediction request). In a particular embodiment, queries may be classified as analytic queries or data connectors. Analytic queries may not be executable until all required fact tables are available. In contrast, data connector queries may be executed independent of fact table availability and may be used to populate fact tables. For example, a data connector query may be executed to load data into in-memory data storage 270 from a database, a web service, a spreadsheet, etc.

To illustrate, “Cost of Turnover” may be a business concept corresponding to a sequence of operations that returns a scalar value as a result. A “Cost of Turnover” query may accept the result of a “Turnover” query as input, and the “Turnover” query may accept an “Organization” and a “Date Range” as input. Thus, a query that computes the Cost of Turnover for a Product Organization during the 2011-2012 year is $373,000 may be represented as:

Cost of Turnover(Turnover(Organization(“Product”,“2011-2012”)))=$373,000

where “Product” and “2011-2012” are parameters and “Organization” and “Turnover” are analytic queries. Thus, higher-order business concepts, such as “Cost of Turnover,” may be bound to queries that can be chained together. The query definitions 252 may include definitions for lower-order and higher-order queries.

The application data 254 may be maintained for each client instance (e.g., the client instances 112 of FIG. 1). The application data 254 for a specific client instance may include server configurations and security policies for the client instance. The application data 254 for a specific client instance may also include a source data model, an analytic data model, and a processor model for the client instance. When the client instance is initialized by a user, the analytics engine 200 may use the application data 254 for the client instance and for the user to determine what databases are available and what data (e.g., from client data 280) should be loaded into the in-memory data storage 270 by data connector queries.

The function declarations 256 may be associated with functions called by the analytic processor 218. For example, the functions may include data transformations or aggregation functions, such as functions to execute a formula, to execute a computation over data representing a calendar year, etc. The functions may also include fetch functions, such as structured query language (SQL) fetch, web service fetch, spreadsheet fetch, etc. The functions may further include exporting functions, such as spreadsheet export and SQL export, and custom (e.g., user defined) functions.

The security modules 258 may implement query security and organizational security. In a particular embodiment, to implement query security, each measure (e.g., cube measure 246 and/or content measure 294) may be bound to one or more queries, and each user may have a particular security level and/or enterprise role. Different security levels and enterprise roles may be assigned access to different measures. Prior to execution of a query, the security modules 258 may determine whether the user requesting execution of the query meets a security level/enterprise role required to access the measures bound to the query. If the user does not meet the security requirements, the analytics engine 200 may return an error message to the requesting client instance.

Organizational security may be applied on the basis of the organization(s) that a user has access to. For example, the manager of the “Products” organization may have access to products-related information, but may not have access to a “Legal” organization. The security modules 258 may grant a user access to information for the user's organization and all organizations descending from the user's organization.

The content model 290 may include definitions 292 for topics and metrics. For example, in the context of workforce analytics, the definitions 292 may include definitions for various human resources (HR) topics and metrics, as well as definitions for questions and analytic concepts associated with such topics and metrics. The content model 290 may also include definitions for content measures 294. Whereas the cube measures 246 are defined with respect to a cube, the content measures 294 may be derived from or built upon a cube measure. For example, given the “Sum of Salary” cube measure described above, a “Sum of Salaries of Employees 50 years or older” content measure can be derived from or built upon the “Sum of Salary” cube measure. Various topics, metrics, and/or questions defined in the definitions 292 may reference the “Sum of Salaries of Employees 50 years or older” content measure.

The calculator 260 may include a function engine 262, an analytic concept builder 264, an aggregator 266, a cube manager 268, and the in-memory data storage (e.g., random access memory (RAM)) 270. The function engine 262 may be used by the analytic processor 218 to load and execute the functions 256. In a particular embodiment, the function engine 262 may also execute user-defined functions or plug-ins. A function may also recursively call back to the analytic processor 218 to execute sub-functions.

When a query requires a set of values corresponding to different dates (e.g., to generate points of a trend chart), the function engine 262 may split a query into sub-queries. Each sub-query may be executed independently. Once results of the sub-queries are available, the function engine 262 may combine the results to generate an overall result of the original query (e.g., by using a “UnionOverPeriod” function). The overall result may be returned to the requesting client instance via the server management module 210.

The analytic concept builder 264 may be a processing function called by the analytic processor 218 to communicate with the calculator 260. If a particular query cannot be evaluated using a single multidimensional cube operation, the query may be split into smaller “chunk” requests. Each chunk request may be responsible for calculating the result of a chunk of the overall query. The analytic concept builder 264 may call back to the analytic processor 218 with chunk requests, and the calculator 260 may execute the chunk requests in parallel. Further, when a large amount of client data 280 is available, the client data 280 may be divided into “shards.” Each shard may be a subset of the client data 280 that matches a corresponding filter (e.g., different shards may include data for different quarters of a calendar year). Shards may be stored on different storage devices (e.g., servers) for load-balancing purposes. If a query requests values that span multiple shards (e.g., a query that requests data for a calendar year), the analytic concept builder 264 may split the query into chunk requests and call back into the analytic processor 218 with a chunk request for each shard.

The cube manager 268 may generate, cache, and lookup cube views. A “cube view” includes a multidimensional cube along with one or more constraints that provide semantics to the cube. For example, given a cube containing employee information, the constraint “Date=2012-07-01” can be added to the cube to form a cube view representing the state of all employees as of Jul. 1, 2012. The cube manager 268 may receive a request for a particular cube view from the analytic concept builder 264. If the requested cube view is available in the cache, the cube manager 268 may return the cached cube view. If not, the cube manager 268 may construct and cache the cube view prior to returning the constructed cube view. A cache management policy (e.g., least recently used, least frequently used, etc.) may be used to determine when a cached cube view is deleted from the cache.

The analytic concept builder 264 may also call into the aggregator 266. When called, the aggregator 266 may determine what cube views, dimensions member(s), and measures are needed to perform a particular calculation. The aggregator 266 may also calculate results from cube views and return the results to the analytic concept builder 264.

The in-memory data storage 270 may store client data 280 for use during query execution. For example, the client data 280 may be loaded into the in-memory data storage 270 using data connector queries called by the analytic processor 218. The in-memory data storage 270 can be considered a “base” hypercube that includes a large number of available dimensions, where each dimension can include a large number of members. In an exemplary embodiment, the base cube is an N-dimensional online analytic processing (OLAP) cube.

During operation, the analytics engine 200 may execute queries in response to requests from client instances. For example, a user may log in to a client instance and navigate to a report that illustrates Turnover Rate for a Products organization in Canada during the first quarter of 2011. The client instance may send a query request for a “Turnover Rate” analytic query to be executed using the parameters: “Products,” “Canada,” and “First Quarter, 2011.” The server management module 210 may receive the query request and may forward the query request to the analytic processor 218.

Upon receiving the query request, the analytic processor 218 may verify that the user has access to the Turnover Rate query and employee turnover data for the Products organization in Canada. If the user has access, the analytic processor 218 may verify that the employee turnover data is stored in the in-memory data storage 270. If the employee turnover data is not stored in the in-memory data storage 270, the analytic processor 218 may call one or more data connector queries to load the data into the in-memory data storage 270.

When the data is available in the in-memory data storage, the analytic processor 218 may look up the definition of the Turnover Rate query in the repository 220. For example, the definition of the Turnover Rate query may include a rate processing function, an annualization processing function, a sub-query for the number of turnovers during a time period, and a sub-query for average headcount during a time period. The function engine 262 may load the rate and annualization processing functions identified by the query definition.

Once the functions are loaded, the analytic processor 218 may call the analytic concept builder 264 to generate cube views. For example, the analytic concept builder 264 may request the cube manager 268 for cube views corresponding to headcount and turnover count. The cube manager 268 may retrieve the requested cube views from the cache or may construct the requested cube views.

The analytic concept builder 264 may execute analytic concepts and call into the aggregator 266 to generate result set(s). For the Turnover Rate query, two result sets may be generated in parallel—a result set for average head count and a result set for number of turnover events. For average headcount, the aggregator 266 may call a measure to obtain four result values based on the “Canada” member of the Locations dimension, the “Products” member of the organizations dimension, and “2010-12-31,” “2011-01-31,” “2011-02-28,” and “2011-03-31” of the time dimension. The four result values may represent the headcount of the Products Organization in Canada on the last day of December 2010, January 2011, February 2011, and March 2011. The aggregator 266 may pass the four values to the analytic concept builder 264. To illustrate, the four values may be headcount=454, headcount=475, headcount=491, and headcount=500.

Similarly, for turnover count, the aggregator 266 may call a measure to obtain a result value based on the “Canada” member of the Locations dimension, the “Products” member of the organizations dimension, and “2011-01,” “2011-02,” and “2011-03” of the time dimension. The three result values may represent the total number of turnover events in the Products Organization in Canada during the months of January 2011, February 2011, and March 2011. The aggregator 266 may pass a sum of the result values to the analytic concept builder 264. To illustrate, the result value may be sum=6.

The analytic concept builder 264 may pass the received values to the analytic processor 218, which may call processing functions to calculate the query result. For example, the analytic processor 218 may call the rate processing function to determine the rate is 1.25% (turnover/average head count=6/480=0.0125). The analytic processor 218 may then call the annualization processing function to determine that the annualized turnover rate is 5% (1.25%*4 quarters=5%). The analytic processor 218 may return the query result of 5% to the client instance via the server management module 210.

It should be noted that the foregoing description, which relates to executing an analytic query to generate a single value, is for example only and not to be considered limiting. Multidimensional queries may also be executed by the analytics engine 200. For example, a user may set his or her application context to “All Organizations” in “Canada” during “2011.” The user may then view a distribution chart for Resignation Rate and select groupings by “Age,” “Location,” and “Gender.” To generate the chart, a multidimensional query may be executed by the analytics engine 200. Thus, queries may be executed to retrieve a set of data (e.g., multiple data items), not just a single value.

In a particular embodiment, the analytics engine 200 is configured to perform multidimensional computations on client data 280. When a user navigates to a prediction GUI in an application (e.g., the client instance 112), a query or a prediction request may be sent to the analytics engine 200. In response to a query, client data 280 corresponding to selected dimension member(s) (e.g., a particular organization, location, etc.) may be loaded into the in-memory data storage 270. Depending on the type of analysis to be performed, peers, ancestors, and/or descendants of the particular dimension member may be identified based on the definitions 292 in the content model 290. The security module 258 may identify whether any of the identified peers or ancestors is unavailable to a user (descendants may be assumed as being available). Client data 280 corresponding to available peers, ancestors, and descendants may be loaded into the in-memory data storage 270. The analytic concept builder 264 may call the cube manager 268 to provide multidimensional cube view(s) corresponding to client data 280 loaded in the in-memory data storage 270. The analytic concept builder 264 may also call the aggregator 266 to compute measure values using the cube view(s). For example, the employee resignation rate for different geographical locations may be computed, as described with reference to FIG. 1. The employee resignation rate may be computed based on a “risk of leaving” model that may be computed as described with reference to FIG. 1. To illustrate, if a large percentage of resigned employees were in the Los Angeles office of an enterprise, then the “Los Angeles” member of the “Location” dimension may be determined as having a large likelihood score (e.g., value of L as determined based on Equation 1). As another example, if zero or a small number of resigned employees were branch managers, then the “Branch Manager” member of the “Employee Role” dimension may be determined as having a small likelihood score. In response to a prediction request, the analytics engine 200 may identify employees that are associated with dimension members having high “risk of leaving” scores, where the “risk of leaving” score for a particular employee is determined based on the likelihood scores for the dimension members associated with the employee. The computation results (e.g., fact data, prediction data, or both) may be returned to the application via the server management module 210.

It will be appreciated that because predicted values apply to individual facts (e.g., records), such as individual employees, predicted values can be determined based on the results of analysis queries. Further, for calculations at the analytics engine 130, predictions may be modelled as calculated values (e.g., in the calculated values 244) based on the facts. To illustrate, an employee's risk of leaving may be a calculated value associated with the employee. It will be appreciated that because such predicted values may be integrated into the analytics engine 200, the predicted values may be summed, counted, and/or measured similar to other data during query execution at the analytics engine 200. For example, to determine a count of employees in “North America” that have a high likelihood of resigning, the analytics engine 200 may count the highest-risk employees in “US,” “Canada,” etc. using a calculated value corresponding to resignation rate and then sum the calculated values. In a particular embodiment, the calculated values may be computed using a mechanism similar to execution of a nested query to obtain likelihood scores (e.g., per Equation 1, above) of all dimension members.

FIG. 2 thus illustrates a server-side system to perform multidimensional computations on client data. Results of the computations may be used by a client instance to generate reports and visualizations, including reports and visualizations for querying, analyzing, reporting, and prediction (QARP).

FIG. 3 illustrates a graphical user interface GUI 300 generated by an application. In an illustrative embodiment, the GUI 300 is generated by one of the client instances 112 of FIG. 1.

In the GUI 300, a topic guide tab 301 is selected. The topic guide may present a high-level list of semantic items (e.g., business topics) that are available for a user (e.g., John Smith (as indicated at 302), who is an employee of the company Bluesphere Enterprises (as indicated at 303)). The GUI 300 also indicates an application context 304. In the illustrated example, the application context is “Bluesphere” in “All Locations.” The application context 304 corresponds to a population of 7,698 employees. As the user (John Smith) changes the application context (e.g., changes the “Location” dimension from “All Locations” to “US,” changes the “Organization” dimension from “Bluesphere” to “Legal,” etc.), the population is dynamically updated. The application context 304 may represent a filter or set of filters that is used during query execution (e.g., to determine an analysis population).

In FIG. 3, the topic guide includes topics for compensation expenses, diversity benchmarking, employment costs benchmarking, learning and development, leave management, manager effectiveness, organizational structure, pay equity, performance management, productivity, recruiting effectiveness, retention, and retirement. One or more of the topics may be selected to view visualizations (e.g., charts and graphs) that show client data, prediction results, or both. For example, a retention topic 306 may be selected to view visualizations related to resignation rates, employees that have a high likelihood of resigning, etc.

FIG. 4 depicts a particular embodiment of a GUI 400 that may be generated by the system 100 of FIG. 1. The GUI 400 corresponds to the retention topic 306 of FIG. 3. Business questions for the retention topic include “How is the resignation rate trending and varying across the enterprise?” and “Which employees have the highest likelihood of resigning?”

A user (e.g., the user 114 of FIG. 1) has selected the root-level “Bluesphere” organization, the “US” location, and the date range “2013” for the application context, as shown at 402.

In the example of FIG. 4, the “How is the resignation rate trending and varying across the enterprise?” business question is selected to show a bar chart visualization. The bar chart visualization includes options to compare resignation rate across time (denoted “Trend” in FIG. 4), “Location”, “Organization”, and “Role”. In FIG. 4, a “Location” option 404 is selected. Thus, the bar chart visualization illustrates, for each country in which the “Bluesphere” organization has employees, a resignation rate for that country over Apr. 1, 2012 to Mar. 31, 2013. To illustrate, for Canada, the Bluesphere enterprise has a resignation rate of 11%. The “Bluesphere” organization has an average resignation rate of 8.1% across all locations, as shown at 406. The various client result values shown in FIG. 4 may be computed in accordance with the operations described with reference to FIGS. 1-2.

FIG. 5 illustrates a GUI 500 that may be generated by the system 100 of FIG. 1. The GUI 500 also corresponds to the retention topic 306 of FIG. 3. For the GUI 500, the business question “Which employees have the highest likelihood of resigning?” has been selected. The resulting visualization is configured to illustrate “Most significant characteristics” (contributing to employee resignation) and “Most at risk employees”. In FIG. 5, a “Most at risk employees” option 504 is selected. Thus, the bar chart visualization illustrates employees of the “Bluesphere” organization that have the highest predicted likelihood of resigning (e.g., highest “risk of leaving” scores). The bar chart visualization identifies employees by name and is arranged in descending order of likelihood.

The GUI 500 includes employee details 508 associated with a selected employee 506 “Evelyn Walsh”. The employee details 508 identify a likelihood (e.g., 22.49%) associated with Evelyn Walsh resigning, as shown at 512. As shown at 514, Evelyn Walsh has the following high-influence characteristics (e.g., dimension members): “Training hours: 24-32 hrs” with L=58.3%, “Provenance: Los Angeles No. 2 Company” with L=18.4%, “Role: Engineering” with L=13.6%, and “Training Expense: $1 k-$2 k” with L=11.8%. In a particular embodiment, the employee details 508 may identify employee characteristics that have a greater than a threshold value (e.g., 10%) of L and/or up to a threshold number (e.g., 5) of employee characteristics.

The employee details 508 identify additional information regarding the employee. For example, the employee details 508 identify that Evelyn Walsh” is associated with an “Engineering” role and a “Software P17” organization, has “Billie Poole” as a direct manager and “Yardley Hernandez” as a top level manager, is female, and has a “2 year” tenure. The employee details 508 indicate a $60,735 weighted cost of exit associated with “Evelyn Walsh”, as shown at 510.

FIG. 6 illustrates a GUI 600 that may be generated by the system 100 of FIG. 1. The GUI 600 also corresponds to the retention topic 306 of FIG. 3. In contrast to the GUI 500 of FIG. 5, which is sorted in descending order of likelihood of resignation, the GUI 600 of FIG. 6 is sorted in descending order of weighted cost of exit.

FIG. 7 illustrates a GUI 700 that may be generated by the system 100 of FIG. 1. The GUI 700 also corresponds to the retention topic 306 of FIG. 3. The GUI 700 illustrates the “Most significant characteristics” related to employee resignation, as shown at 704. Thus, the bar chart visualization illustrates characteristics with high L scores (e.g., corresponding to the characteristics 184 of FIG. 1).

FIG. 8 illustrates a GUI 800 that may be generated by the system 100 of FIG. 1. The GUI 800 also corresponds to the retention topic 306 of FIG. 3. In FIG. 8, a “Role: Intern” is selected, as shown at 808. Thus, the bar chart visualization illustrates weighted costs of exit of the highest-risk employees that satisfy “Role: Intern”. It should be noted that in alternate embodiments, prediction data may be filtered based on dimensions other than employee role.

Thus, as illustrated in FIGS. 3-8, a QARP application may generate GUI(s) that include a “raw” value for each population member (e.g., employee) and a weighted likelihood, each of which may be calculated values (e.g., in the calculated values 244 of FIG. 2). In a particular embodiment, an average risk of leaving for various groups of employees (e.g., dimension members) may also be computed and displayed (e.g., on a bar chart), as shown in FIG. 4. It will thus be appreciated that the described techniques may enable integrating predictive modeling into an analytics engine (e.g., the analytics engine 130 of FIG. 1 or the analytics engine 200 of FIG. 2) in addition to querying, reporting, and analytics capabilities.

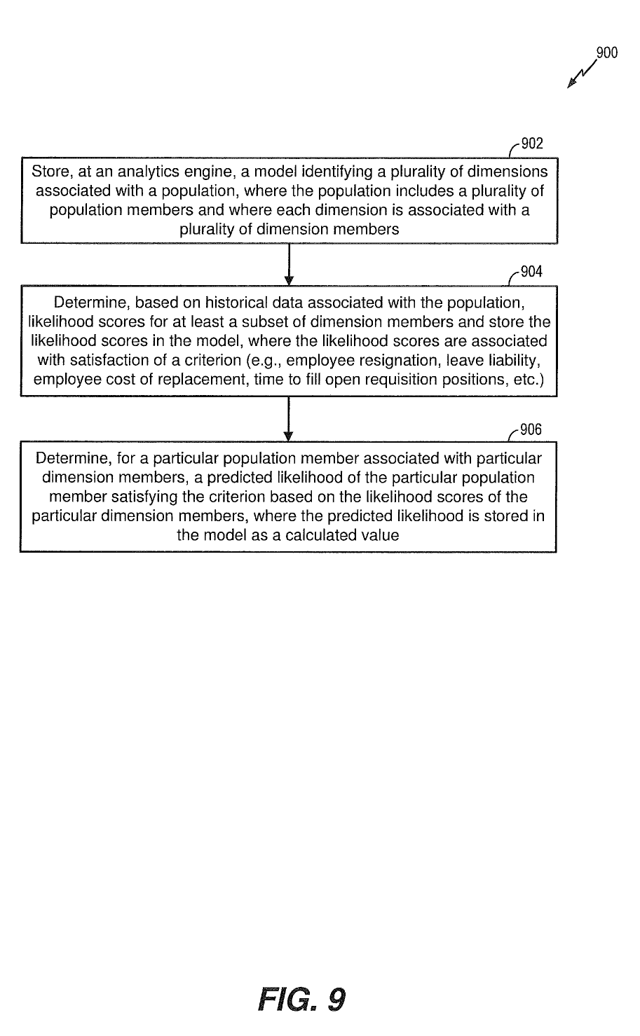

Referring to FIG. 9, a flowchart illustrates a particular embodiment of a method 900 of operation at an analytics engine. In an illustrative embodiment, the method 900 may be performed by the analytics engine 130 of FIG. 1 and/or the analytics engine 200 of FIG. 2.

The method 900 includes storing, at an analytics engine, a model identifying a plurality of dimensions associated with a population, at 902. The population includes a plurality of population members and each dimension is associated with a plurality of dimension members. In an illustrative embodiment, the population is all employees of an enterprise, and the dimensions are employee characteristics, such as location, role, salary, etc.

The method 900 also includes determining, based on historical data associated with the population, likelihood scores for at least a subset of dimension members and storing the likelihood scores in the model, at 904. The likelihood scores are associated with satisfaction of a criterion. As illustrative, non-limiting examples, the criterion may be associated with employee resignation, leave liability, cost of replacement, time to fill open requisition positions, etc. To illustrate, the historical data may indicate employees that have resigned for at least a portion of the previous 18 months, and the likelihood score for each dimension member may be calculated based on Equation 1, as described with reference to FIG. 1. Thus, an employee resignation model may be globally computed on the basis of the entire population (instead of any particular analysis subset of the population).

The method 900 further includes determining, for a particular population member associated with particular dimension members, a predicted likelihood of the particular population member satisfying the criterion based on the likelihood scores of the particular dimension members, at 906. The predicted likelihood is stored in the model as a calculated value. To illustrate, the predicted likelihood of an employee resigning may correspond to the employee's “risk of leaving” score, which may be computed as an average of the top 5 likelihood scores for the employee, as described with reference to FIG. 1. The method 900 of FIG. 9 may enable integrating predictive modeling and computation in an analytics engine, such as the analytics engine 130 of FIG. 1 or the analytics engine 200 of FIG. 2.

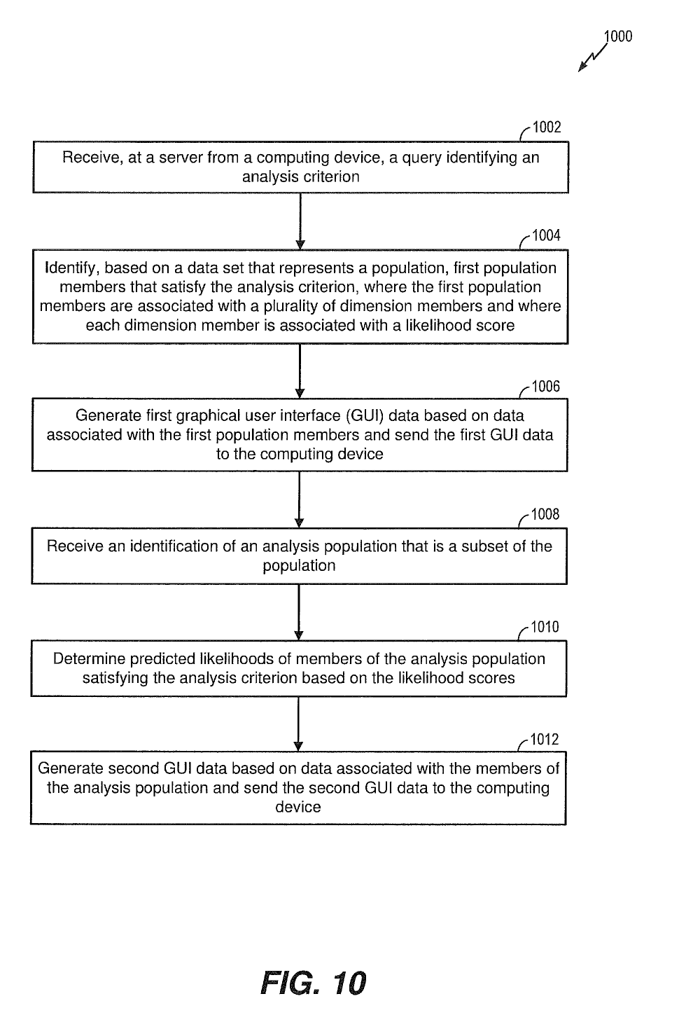

Referring to FIG. 10, a flowchart illustrates another particular embodiment of a method 1000 of operation at an analytics engine. In an illustrative embodiment, the method 1000 may be performed by the analytics engine 130 of FIG. 1 and/or the analytics engine 200 of FIG. 2.

The method 1000 includes receiving, at a server from a computing device (e.g., client), a query identifying an analysis criterion, at 1002. For example, the analytics engine 130 of FIG. 1 may receive the query 142 from the client instance 112, where the query 142 identifies the analysis criterion 102 (e.g., employee resignation).

The method 1000 also includes identifying, based on a data set that represents a population, first population members that satisfy the analysis criterion, at 1004. The first population members are associated with a plurality of dimension members and each dimension member is associated with a likelihood score (e.g., a score that is computed based on Equation 1 as described with reference to FIG. 1). For example, the analytics engine 130 of FIG. 1 may identify the first members 174, where each of the first members 174 is an employee that has resigned within the previous twelve months, eighteen months, etc.

The method 1000 further includes generating first GUI data based on data associated with the first population members and sending the first GUI data to the computing device, at 1006. For example, the analytics engine 130 of FIG. 1 may generate the first GUI data 148 based on the data associated with the first members 174. In an illustrative embodiment, the first GUI data indicates resignation rates for different locations (e.g., as illustrated by the GUI 400 of FIG. 4), dimension members having high likelihood scores for employee resignation (e.g., as illustrated by the GUI 700 of FIG. 7), etc.

The method 1000 further includes receiving an identification of an analysis population that is a subset of the population, at 1008. The identification of the analysis population may be received in a prediction request (e.g., the prediction request 152 of FIG. 1), as part of an application context (e.g., the application context 302 of FIG. 3), etc. The analysis population is a subset of the overall population from which the model was generated.

The method 1000 further includes determining predicted likelihoods of members of the analysis population satisfying the analysis criterion based on the likelihood scores, at 1010. For example, the predicted likelihoods may correspond to “risk of leaving” scores computed as described with reference to FIG. 1.

The method 1000 also includes generating second GUI data based on data associated with the members of the analysis population and sending the second GUI data to the computing device, at 1012. For example, the analytics engine 130 of FIG. 1 may send the second GUI data 158 to the client instance 112. The second GUI data 158 may identify employees determined to have a high likelihood of resigning, a weighted cost estimate of resignation, other employee characteristics (e.g., organization, direct manager, tenure, etc.), or any combination thereof. For example, the second GUI data 158 may be used to generate one or more of the GUIs of FIGS. 4-8. Thus, the method 1000 of FIG. 10 may enable an analytics engine, such as the analytics engine 130 of FIG. 1 or the analytics engine 200 of FIG. 2, to provide querying and analysis capability (e.g., “What are the resignation rates in the US, Canada, and the UK?”), reporting capability (e.g., the GUIs of FIGS. 3-8), and prediction capabilities (e.g., “Which employees in the US are the most likely to resign?”).

In accordance with various embodiments of the present disclosure, the methods, functions, and modules described herein may be implemented by software programs executable by a computer system. Further, in exemplary embodiments, implementations can include distributed processing, component/object distributed processing, and parallel processing. Alternatively, virtual computer system processing can be used to implement one or more of the methods or functionality as described herein.

Particular embodiments can be implemented using a computer system executing a set of instructions that cause the computer system to perform any one or more of the methods or computer-based functions disclosed herein. A computer system may include a laptop computer, a desktop computer, a mobile phone, a tablet computer, or any combination thereof. The computer system may be connected, e.g., using a network, to other computer systems or peripheral devices. For example, the computer system or components thereof can include or be included within any one or more of the devices, systems, modules, and/or components illustrated in or described with reference to FIGS. 1-10. In a networked deployment, the computer system may operate in the capacity of a server or as a client user computer in a server-client user network environment, or as a peer computer system in a peer-to-peer (or distributed) network environment. The term “system” can include any collection of systems or sub-systems that individually or jointly execute a set, or multiple sets, of instructions to perform one or more computer functions.

In a particular embodiment, the instructions can be embodied in one or more computer-readable or a processor-readable devices, such as a centralized or distributed database, and/or associated caches and servers. The terms “computer-readable device” and “processor-readable device” also include device(s) capable of storing instructions for execution by a processor or causing a computer system to perform any one or more of the methods or operations disclosed herein. Examples of such devices include, but are not limited to, random access memory (RAM), flash memory, read-only memory (ROM), programmable read-only memory (PROM), erasable programmable read-only memory (EPROM), electrically erasable programmable read-only memory (EEPROM), register-based memory, solid-state memory, a hard disk, a removable disk, a disc-based memory (e.g., compact disc read-only memory (CD-ROM)), or any other form of storage device. A computer-readable or processor-readable device is not a signal.

In a particular embodiment, an analytics engine includes a processor and a memory storing instructions that, when executed by the processor, cause the processor to perform operations including storing data (e.g., corresponding to a data model, such as a source data model as described with reference to FIG. 2) identifying a plurality of dimensions associated with a population, where the population includes a plurality of population members and where each dimension is associated with a plurality of dimension members. The operations also include determining, based on historical data associated with the population, likelihood scores for at least a subset of dimension members, wherein the likelihood scores are associated with satisfaction of a criterion. The operations further include determining for a particular population member associated with particular dimension members, a predicted likelihood of the particular population member satisfying the criterion based on the likelihood scores of the particular dimension members. The predicted likelihood is stored (e.g., in the data model) as a calculated value.

In another particular embodiment, a method includes receiving, at a server from a computing device, a query identifying an analysis criterion. The method also includes identifying, based on a data set that represents a population, first population members that satisfy the analysis criterion. The first population members are associated with a plurality of dimension members and each of the plurality of dimension members is associated with a likelihood score. The method further includes generating first graphical user interface (GUI) data based on data associated with the first population members and sending the first GUI data to the computing device. The method further receiving an identification of an analysis population that is a subset of the population and determining, based on the likelihood scores, predicted likelihoods of members of the analysis population satisfying the analysis criterion. The method further includes generating second GUI data based on data associated with the members of the analysis population and sending the second GUI data to the computing device.

In another particular embodiment, a computer-readable storage device stores instructions that, when executed by a processor, cause the processor to perform operations including storing data identifying a plurality of dimensions associated with a population, where the population includes a plurality of population members and where each dimension is associated with a plurality of dimension members. The operations also include determining, based on historical data associated with the population, likelihood scores for at least a subset of the plurality of dimension members, wherein the likelihood scores are associated with satisfaction of a criterion. The operations further include determining for a particular population member associated with particular dimension members, a predicted likelihood of the particular population member satisfying the criterion based on likelihood scores of the particular dimension members. The predicted likelihood is stored as a calculated value.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments.

The above-disclosed subject matter is to be considered illustrative, and not restrictive, and the appended claims are intended to cover all such modifications, enhancements, and other embodiments, which fall within the true scope of the present disclosure. Thus, to the maximum extent allowed by law, the scope of the present disclosure is to be determined by the broadest permissible interpretation of the following claims and their equivalents, and shall not be restricted or limited by the foregoing detailed description.

1. An analytics engine comprising:
a processor; and
a memory storing instructions that, when executed by the processor, cause the processor to perform operations comprising:
storing data identifying a plurality of dimensions associated with a population, wherein the population comprises a plurality of population members and wherein each dimension is associated with a plurality of dimension members that corresponds to a plurality of hierarchically arranged data values of the dimension, wherein the population corresponds to employees of an enterprise and wherein each of the population members corresponds to a particular employee of the enterprise;
receiving a query, a prediction request, or a combination thereof that identifies a criterion;
determining, based on historical data associated with the population, likelihood scores for at least a subset of the plurality of dimension members, wherein the likelihood scores are associated with satisfaction of the criterion;
determining, for a particular population member associated with particular dimension members, a predicted likelihood of the particular population member satisfying the criterion based on the likelihood scores of the particular dimension members, wherein the likelihood scores are determined based on a ratio of a first value to a second value, and wherein the first value corresponds to a number of population members associated with the dimension member that satisfy the criterion and the second value corresponds to a total number of population members that satisfy the criterion; and
generating a graphical user interface (GUI) that indicates the predicted likelihood of the particular population member satisfying the criterion.

2. The analytics engine of claim 1, wherein the predicted likelihood is stored as a calculated value in a data model and wherein the operations further comprise storing the likelihood scores in the data model.

3-4. (canceled)

5. The analytics engine of claim 1, wherein the criterion is associated with employee resignation.

6. The analytics engine of claim 1, wherein the criterion is associated with leave liability.

7. The analytics engine of claim 1, wherein the criterion is associated with employee cost of replacement.

8. The analytics engine of claim 1, wherein the criterion is associated with time to fill open requisition positions.

9. The analytics engine of claim 1, wherein the predicted likelihood is stored as a calculated value and wherein the operations further comprise:
determining first predicted likelihoods for each population member in a first analysis population based on the calculated value;
determining second predicted likelihoods of each population member in a second analysis population based on the calculated value; and
performing at least one operation with respect to the first predicted likelihoods and the second predicted likelihoods to determine a result value, wherein the at least one operation includes a sum operation, a count operation, or a combination thereof.

10. A method comprising:
receiving, at a server from a computing device, a query identifying an analysis criterion;
identifying, based on a data set that represents a population, first population members that satisfy the analysis criterion, wherein the first population members are associated with a plurality of dimension members that corresponds to a plurality of hierarchically arranged data values of a dimension and wherein each of the plurality of dimension members is associated with a likelihood score that is calculated based on historical data associated with the population;
generating a first graphical user interface (GUI) that identifies the first population members that satisfy the analysis criterion;
receiving an identification of an analysis population that is a subset of the population;
determining, based on the likelihood scores, predicted likelihoods of members of the analysis population satisfying the analysis criterion, wherein the likelihood scores are determined based on a ratio of a first value to a second value, and wherein the first value corresponds to a number of population members associated with the dimension member that satisfy the analysis criterion and the second value corresponds to a total number of population members that satisfy the analysis criterion; and
generating a second GUI that indicates the predicted likelihoods of members of the analysis population satisfying the analysis criterion.

11. (canceled)

12. The method of claim 10, wherein:
the population corresponds to employees of an enterprise;
the first population members correspond to first employees of the enterprise that have resigned;
the members of the analysis population correspond to second employees of the enterprise that have not resigned; and
the second GUI indicates predicted likelihoods of one or more employees in the analysis population resigning.

13. (canceled)

14. The method of claim 10, wherein the first GUI identifies at least one dimension member having a likelihood score that is greater than a threshold.

15. The method of claim 12, further comprising:
receiving a selection of a particular employee indicated by the second GUI; and
generating a third GUI associated with the particular employee,
wherein the third GUI indicates the predicted likelihood of the particular employee resigning, and
wherein the third GUI indicates likelihood scores of dimension members that contribute to the predicted likelihood of the particular employee resigning.

16. The method of claim 15, wherein the third GUI identifies an estimated cost of resignation of the particular employee.

17. The method of claim 10, wherein the analysis population corresponds to a particular geographic location.

18. The method of claim 10, wherein the analysis population corresponds to a particular organization of an enterprise.

19. A computer-readable storage device storing instructions that, when executed by a processor, cause the processor to perform operations comprising:
storing, at an analytics engine, data identifying a plurality of dimensions associated with a population, wherein the population comprises a plurality of population members and wherein each dimension is associated with a plurality of dimension members that corresponds to a plurality of hierarchically arranged data values of the dimension, wherein the population corresponds to employees of an enterprise and wherein each of the population members corresponds to a particular employee of the enterprise;
receiving a query, a prediction request, or a combination thereof that identifies a criterion;
determining, based on historical data associated with the population, likelihood scores for at least a subset of the plurality of dimension members, wherein the likelihood scores are associated with satisfaction of the criterion;
determining, for a particular population member associated with particular dimension members, a predicted likelihood of the particular population member satisfying the criterion based on the likelihood scores of the particular dimension members, wherein the likelihood scores are determined based on a ratio of a first value to a second value, and wherein the first value corresponds to a number of population members associated with the dimension member that satisfy the criterion and the second value corresponds to a total number of population members that satisfy the criterion; and
generating a graphical user interface (GUI) that indicates the predicted likelihood of the particular population member satisfying the criterion.

20. (canceled)

21. The analytics engine of claim 1, wherein the query, the prediction request, or a combination thereof is received from a client instance via a network.

22. The analytics engine of claim 1, wherein the GUI indicates employees having high likelihoods of leaving the enterprise.

23. The analytics engine of claim 1, wherein the GUI indicates employee characteristics that have a high correlation with leaving the enterprise.

24. The analytics engine of claim 1, wherein the GUI further indicates likelihood scores of dimension members that contribute to the predicted likelihood of the particular employee satisfying the criterion.

25. The analytics engine of claim 24, wherein the GUI further indicates at least one dimension member having a likelihood score that is greater than a threshold.
